(19) United States
(12) Patent Application Publication
(10) Pub. No.: US 2011/0285388 A1
(43) Pub. Date: Nov. 24, 2011

(54) Power Transmission Belt Formed with Encoder and Method of Manufacturing Same

(76) Inventors: Masanori Tomioka, Okayama (JP); Seiji Omura, Aichi (JP)

(21) Appl. No.: 13/144,339

(22) PCT Filed: Jul. 24, 2009
(86) PCT No.: PCT/JP2009/063242

§ 371 Date: Jul. 13, 2011

(30) Foreign Application Priority Data
Jan. 6, 2009 (JP) 2009-007186 2009

(51) Int. Cl. G01B 7/24; B32B 37/20; F16G 1/06

(52) U.S. Cl. 324/209; 474/237; 156/137

(57) ABSTRACT

A power transmission belt formed with an encoder on its surface, method of manufacturing the power transmission belt, and a load detection system using the power transmission belt. The power transmission belt comprises a band-like magnetic rubber layer provided in a part of a belt layer structure of the power transmission belt which transmits power to an auxiliary machine of an automobile engine along the longitudinal direction of the belt layer structure. The surface of the magnetic rubber layer constitutes a multipolar magnetized surface alternately provided with N-poles and S-poles along the longitudinal direction of the belt layer structure, the surface of the magnetic rubber layer is capable of outputting signals for calculating load applied to the belt layer structure by the auxiliary machine to a plurality of magnetic sensors provided along the longitudinal direction of the belt layer structure, and one of the sensors is provided at a position where the auxiliary machine is provided.

### TECHNICAL FIELD

The present invention relates to an endless power transmission belt, and more particularly to a power transmission belt formed with an encoder on its surface capable of detecting rotation and elongation of the belt and its production method, the power transmission belt including the power transmission belt of auxiliary machines such as an alternator, a water pump, an air conditioner and the like of an automotive engine and the power transmission belt of other industrial machines.

### BACKGROUND ART

Endless power transmission belts are wound and wrapped from crank pulleys of the engine to pulleys of auxiliary machines in order to transmit power via the belt to the auxiliary machines such as an alternator, a water pump, an air conditioner and the like of the automotive engine. The load from such auxiliary machines affects travelling performance and fuel consumption of automobiles, so that it is important to detect the load from the auxiliary machines to optimize torque control design of the engines. Such load is represented as temporary elongation of the belts when the auxiliary machines are driven. In addition, long-time driving increases fatigue accumulation of the belts, so that normal power transmission may not be executed for the auxiliary machines and the belts may be elongated.

Based on this standpoint, the Patent Literature 1 discloses that a sensor constituted with a hall element and a magnetic material is provided with an auto-tensioner keeping constant the tensile force of a power transmission belt transmitting power to an auxiliary machine of an automobile such as an alternator and whether the conditions of the belt (elongated condition) are normal or abnormal is determined by detecting the rotational angle of the actuator of the auto-tensioner. The Patent Literatures 2 and 3 do not relate to the power transmission belt for an auxiliary machine, however, they disclose open-close operations of a suction valve and an exhaust valve are appropriately controlled by detecting the phase difference between a crank angle and a cam angle generated by elongation of a timing chain and a timing belt which transmit power from a crank shaft of an engine to a cam shaft.

The Patent Literatures 4 and 5 disclose that a rubber magnet is embedded in a conveyor belt or a sheet-like rubber magnet is adhered to the surface of a conveyor belt and the magnetic change accompanied with movement of the rubber magnet is detected by a magnetic sensor provided close to the conveyor, thereby detecting elongation of the conveyor belt.

### CITATION LIST

### Patent Literature

PTL 1: JP-A-2006-144960
PTL 2: JP-A-2001-164980
PTL 3: JP-A-2002-309994
PTL 4: JP-A-2005-106761
PTL 5: JP-A-2006-44853

### SUMMARY OF INVENTION

### Technical Problem

In the related art disclosed in the Patent Literature 1, elongation of the belt driving the auxiliary machine is not directly detected, so that the torque control of an engine is not expected to be optimized by detecting temporary elongation of the belt generated when load is applied by the auxiliary machine each time. Furthermore, in the related arts disclosed in the Patent Literatures 2, 3, the phase difference between the crank angle and the cam angle is detected based on elongation of the timing chain and the timing belt, however, they do not describe an objective medium of which an angle is detected (signal producing medium). Even more, they do not intend to control the torque of the engine taking into consideration the load by the auxiliary machine.

In the related arts in the Patent Literatures 4, 5, elongation of a conveyor belt is directly detected by detecting the magnetic change in the magnetic rubber embedded in or adhered to the conveyor belt. However, it cannot be concluded that such related arts are applicable to a power transmission belt driven under severe conditions such that the belt rotates at high speed and is bent by pulleys. In addition, they disclose the rubber magnet is embedded in the conveyor belt or the sheet-like rubber magnet is adhered to the surface of the conveyor belt, however, they do not describe how the rubber magnet is embedded or adhered. Furthermore, it is expected to be very hard to accurately place the intervals between the rubber magnets when a plurality of rubber magnets are embedded or adhered, so that there is a worry about a reliability of detection accuracy of elongation of the belt when such related arts are applied to the power transmission belt which rotates at high speed.

The present invention is proposed in view of the above-mentioned problems, its object is to provide a power transmission belt formed with an encoder on its surface which achieves the right quality as a power transmission belt although being simply constructed and can accurately generate rotation detection information including elongation of the belt, and to provide its production method.

### Solution to Problem

A power transmission belt formed with an encoder on its surface in the first invention has a band-like magnetic rubber layer in a part of a belt layer structure of the power transmission belt along its longitudinal direction, and the power transmission belt is characterized in that a surface of the magnetic rubber layer constitutes a multipolar magnetized surface alternately provided with N-poles and S-poles along the longitudinal direction of the belt layer structure.

According to the power transmission belt formed with an encoder in the present invention, the surface of the magnetic rubber layer can expose onto a surface of the belt layer structure. In this case, the magnetic rubber layer can be designed in such a manner that the surface of the magnetic rubber layer becomes identical to the surface of the belt layer structure. In addition, the magnetic rubber layer may be continuously formed all around the circumference of the belt layer structure or a plurality of the magnetic rubber layers may be formed at intervals all around the circumference of the belt layer structure, either of which can be appropriately selected depending on the intended use. In these cases, the N-poles and the S-poles can be provided at equal intervals. Furthermore, it is desirable that the magnetic rubber layer be integrally adhered to the belt layer structure with a rubber-based adhesive agent.

A production method of the power transmission belt formed with an encoder on its surface in the second invention comprises the steps of applying an uncured rubber-based adhesive agent onto the belt layer structure of the power transmission belt along its longitudinal direction, placing on a part applied with the adhesive agent a magnetic rubber material prepared in advance by mixing magnetic powder with an unvulcanized rubber material, heating all the structures at a vulcanization temperature of the unvulcanized rubber material to fixedly form the magnetic rubber layer of which a surface exposes onto the surface of the belt layer structure, and thereafter forming the multipolar magnetized surface by alternately providing N-poles and S-poles at equal intervals along its longitudinal direction of the belt layer structure.

Furthermore, a production method of the power transmission belt formed with an encoder on its surface in the third invention comprises the steps of applying a rubber-based adhesive agent onto the belt layer structure of the power transmission belt along its longitudinal direction, and placing the band-like magnetic rubber sheet on a part applied with the rubber-based adhesive agent to be integrally adhered, a surface of the band-like magnetic rubber sheet constituting a multipolar magnetized surface by alternately providing N-poles and S-poles at equal intervals along its longitudinal direction.

In the production method of the power transmission belt formed with an encoder, the adhesive agent may be applied onto a removed part of the belt layer structure and the magnetic rubber layer may be integrally formed with the removed part by means of the adhesive agent. In such integration of the magnetic rubber layer, the surface of the magnetic rubber layer becomes identical to the surface constituting the belt layer structure.

Furthermore, in the production method of the power transmission belt formed with an encoder, the magnetic rubber layer may be continuously formed all around the circumference of the belt layer structure or a plurality of the magnetic rubber layers may be formed at intervals around the circumference of the belt layer structure.

### Advantageous Effects of Invention

According to a power transmission belt formed with an encoder on its surface in the first invention, the band-like magnetic rubber layer constituting a part of the belt layer structure of the power transmission belt is along the longitudinal direction of the belt layer structure, and the surface of the magnetic rubber layer constitutes the multipolar magnetized surface alternately provided with N-poles and S-poles along the longitudinal direction of the belt layer structure. Therefore, if a magnetic sensor is provided close to the belt to detect the magnetic change by rotation of the belt, rotary speed and the like can be detected by the regular magnetic change. Specifically, when N-poles and S-poles are provided at equal intervals, the detection accuracy of rotary speed and the like by the regular magnetic change can be improved.

The magnetic rubber layer is along the longitudinal direction of the belt layer structure, so that it elongates or contracts by the rubber-like characteristic according to elongation or contraction of the belt. Therefore, when the rubber layer elongates or contracts according to the belt, the equally-spaced relation of each N-pole and S-pole is maintained. When the magnetic change by rotation of the belt is detected by the magnetic sensor, regular pulse signals are generated from the magnetic rubber layer. Because the widths of the pulse signals become different depending on elongation of the belt, the rate of elongation can be simply determined by comparing the elongated pulse width with the pulse width when the belt does not elongate. Accordingly, the largest load applied to the belt by a driven side can be calculated, optimization of the belt width and torque control at a driving source side can be achieved based on the calculation, and fuel economy is improved if such a belt is applied as belts for auxiliary machines of automobiles.

The magnetic rubber layer is designed to expose onto the surface of the belt layer structure, and the above-mentioned rotational information can be accurately generated because the surface constitutes a multi-polar magnetized surface. In addition, the magnetic rubber layer elongates or contracts according to the belt layer structure, so that such a belt can be used as a power transmission belt applicable in severe conditions wherein the rotary speed of the belt is high and the belt is bent by many pulleys.

If the magnetic rubber layer is designed in such a manner that its surface becomes identical to the surface of the belt layer structure, the magnetic rubber layer does not deteriorate smooth power transmission even when the belt in the present invention is applied to the belting structure of power transmission system in which the magnetic rubber layer comes into contact with a pulley.

In addition, when the magnetic rubber layer is integrally adhered to the belt layer structure with the rubber-based adhesive agent, the followability of the magnetic rubber layer to the elongation or contraction of the belt is improved by the rubber-like characteristic of the adhesive agent and rotation (elongation) detection information with high accuracy can be obtained.

According to a production method of the power transmission belt formed with an encoder in the second invention, the magnetic rubber material prepared by mixing magnetic powder with the unvulcanized rubber material is placed on the part applied with the adhesive agent of the belt layer structure of the power transmission belt and all the structures are heated at a vulcanization temperature of the unvulcanized rubber material, thereby fixedly forming the magnetic rubber layer. Therefore, vulcanizing and curing of the unvulcanized rubber, and curing of the rubber-based adhesive agent are executed in parallel and the magnetic rubber layer and the belt layer structure are integrated safely and strongly. In addition, after fixedly forming the magnetic rubber layer, the multipolar magnetized surface is formed on the surface of the magnetic rubber layer by alternately providing N-poles and S-poles at equal intervals along the longitudinal direction of the belt layer structure, so that magnetizing can be executed with a known magnetizing apparatus and such an arrangement of N-poles and S-poles alternately at equal intervals can be accurately formed.

Furthermore, according to a production method of the power transmission belt formed with an encoder in the third invention, the band-like magnetic rubber sheet formed with the multipolar magnetized surface by alternately providing N-poles and S-poles at equal intervals along its longitudinal direction is prepared in advance. Therefore, such an arrangement of N-poles and S-poles alternately at equal intervals can be accurately formed on the belt-like magnetic rubber sheet by means of a known magnetizing apparatus. Then, the belt-like magnetic rubber sheet is placed on the part of the belt layer structure applied with the rubber based adhesive agent to be integrally adhered, thereby forming the magnetic rubber layer while keeping the arrangement of the N-poles and the S-poles on the belt-like magnetic rubber sheet.

In such a power transmission belt formed with an encoder on its surface, when the adhesive agent is applied onto the partially removed part of the belt layer structure and the magnetic rubber layer is integrally formed with the removed part by means of the adhesive agent, the magnetic rubber layer can be safely and firmly integrated to the belt layer structure. In addition, the surface of the magnetic rubber layer can easily become identical to the surface constituting the belt layer structure.

In the first, second and the third inventions, when the magnetic rubber layer is continuously formed all around the circumference of the belt layer structure, the regularity of the pulse generation can be obtained all around the belt, thereby obtaining rotation detection information at high accuracy. If a plurality of magnetic rubber layers are formed at intervals around the circumference of the belt layer structure, the material cost is reduced and the belt performance is not deteriorated; in addition, the regularity of pulse generation of each magnetic rubber layer can be obtained, so that the rotation detection information at high accuracy can be obtained as mentioned above by consisting with the detection timing.

In this embodiment, the rubber material constituting the magnetic rubber layer is preferably a rubber material selected from NBR, H-NBR, ACM, AEM, FKM and the like. The magnetic powder includes ferrite based magnetic powder or rare earth based magnetic powder. Such magnetic powder contains at 70 to 95 weight percent in the magnetic rubber layer. In addition, an adhesive agent preferably contains a flexible rubber or resin such as a natural rubber adhesive, a chloride rubber adhesive, a butyl rubber adhesive, a polyurethane adhesive, a silicone adhesive, a nitrile rubber adhesive, a styrene-butadiene rubber adhesive, an ethylene-vinyl acetate adhesive, an acrylic adhesive, and the like. Or an epoxy resin, a phenol resin, an amide resin, a urea resin, a vinyl chloride resin, an imide resin, or a coupling agent may be blended in the adhesive agent. The degree of extension of the magnetic rubber layer and the cured rubber based adhesive agent is preferably more than 10 percent considering the followability of the extension of the belt layer structure.

### BRIEF DESCRIPTION OF DRAWINGS

FIG. 1 is a partially broken perspective view showing one embodiment of a power transmission belt formed with an encoder on its surface according to the present invention.

FIG. 2 is a similar drawing to FIG. 1 according to another embodiment.

FIG. 3a to FIG. 3g are sectional views of respective modified embodiments of a power transmission belt formed with an encoder on its surface according to the present invention.

FIG. 4 is a conceptual diagram when a power transmission belt formed with an encoder on its surface according to the present invention is applied to a belt of an auxiliary machine for engine and a rotation detection system of the belt is constituted.

FIG. 5 is a time chart showing rotation detection pulse signals in the rotation detection system.

FIG. 6 is a flow chart showing one embodiment of a production method of a power transmission belt formed with an encoder on its surface according to the present invention.

FIG. 7 is a conceptual diagram showing one example of a fixing and forming procedure of a magnetic rubber layer according to the production method.

FIG. 8 is a similar drawing showing another example of the procedure.

FIG. 9 is a flow chart showing another embodiment of the production method of a power transmission belt formed with an encoder on its surface according to the present invention.

### DESCRIPTION OF EMBODIMENTS

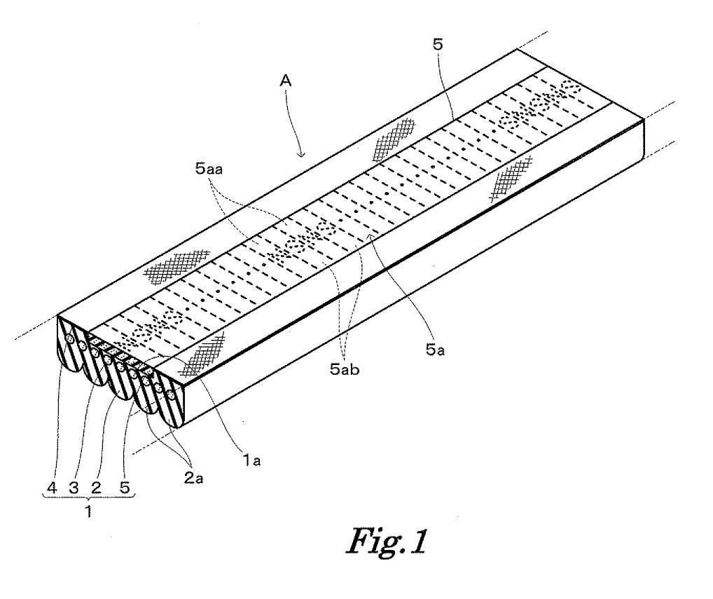

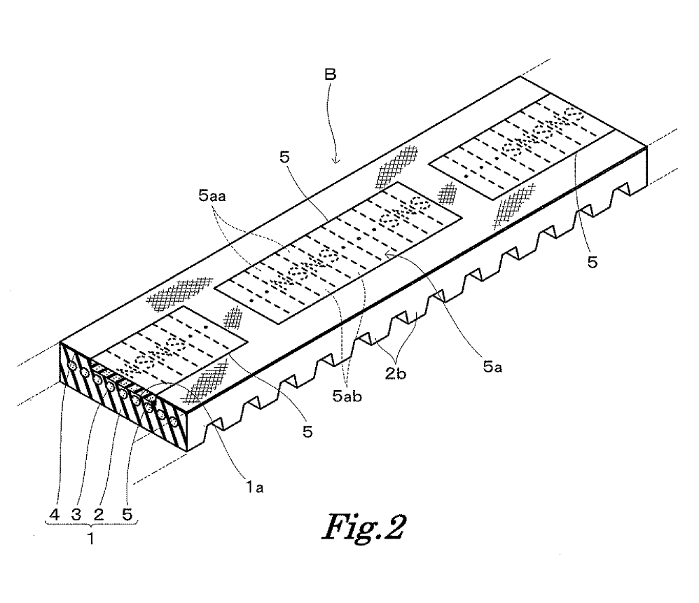

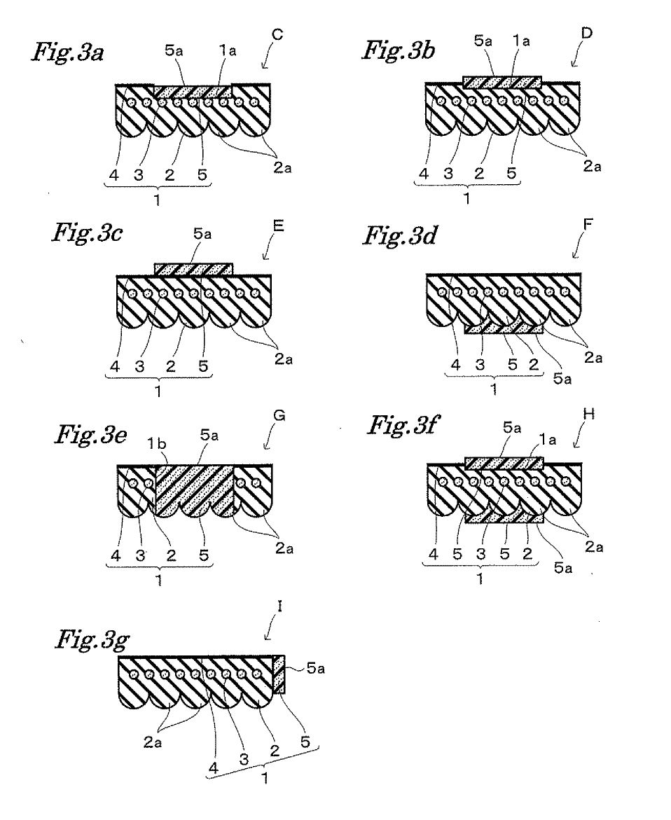

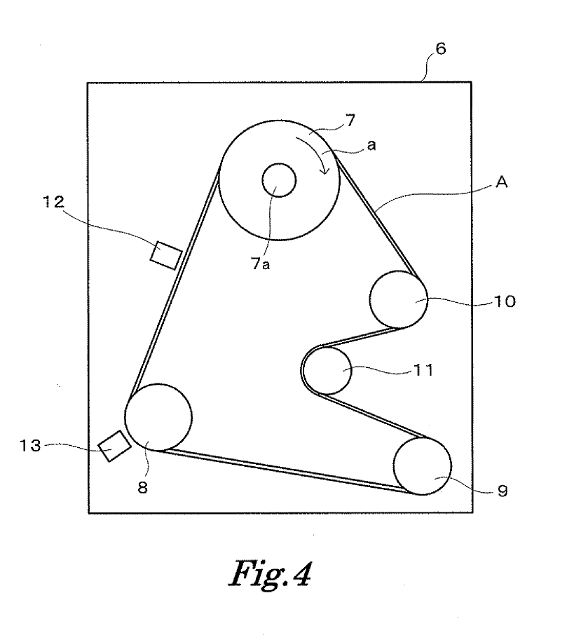

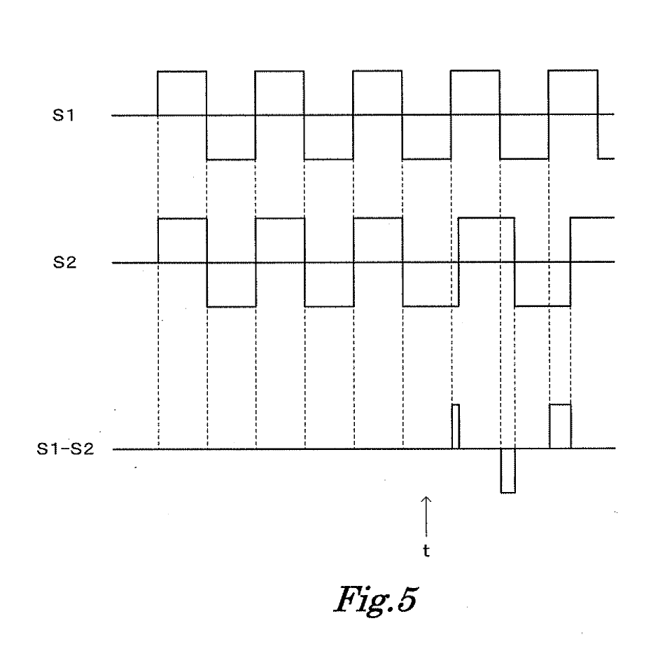

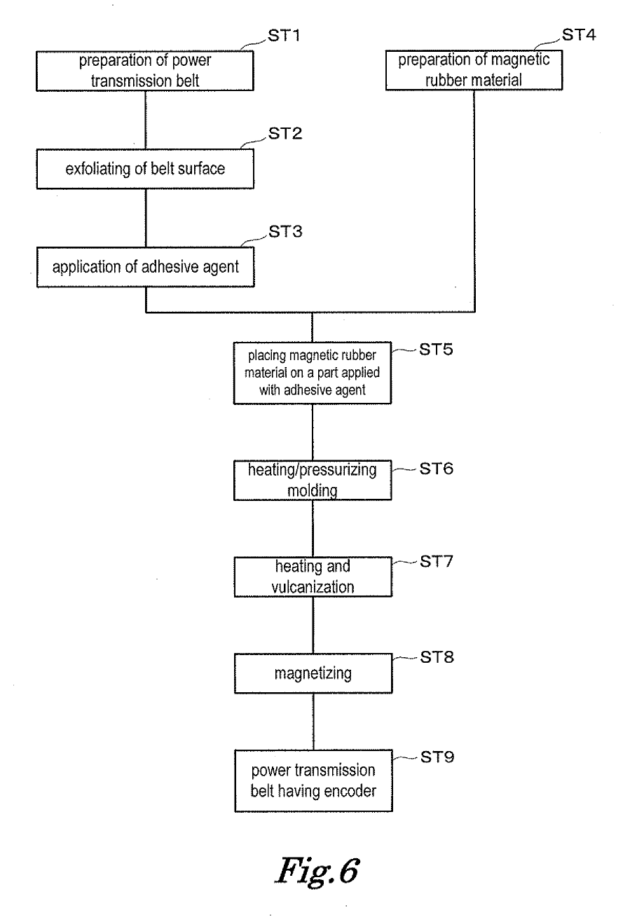

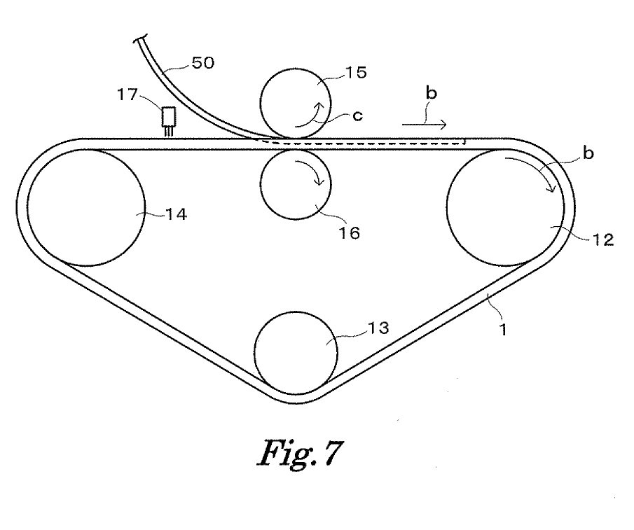

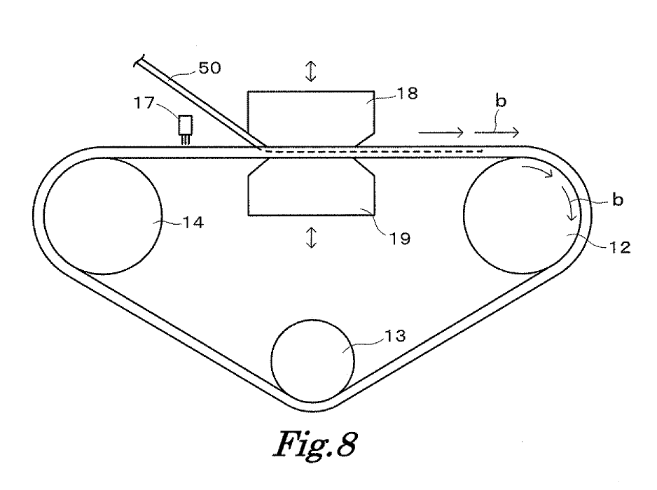

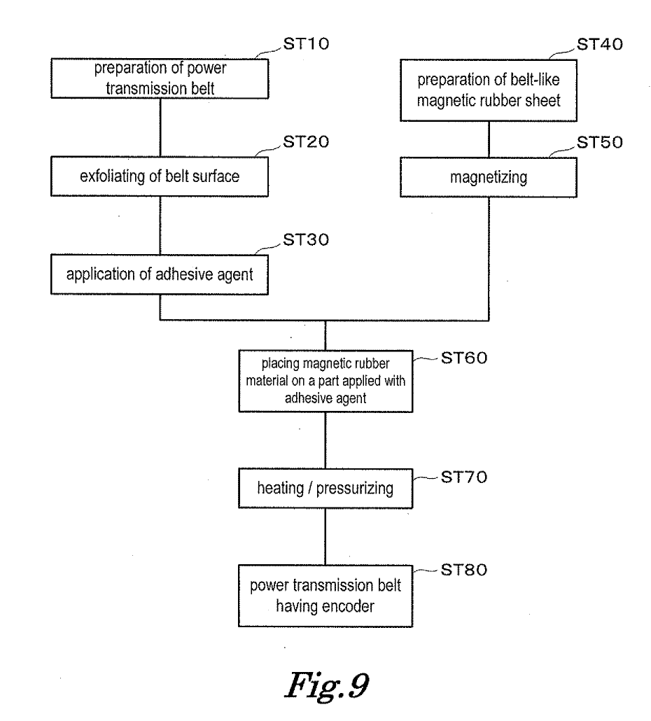

The preferred embodiments according to the present invention are explained based on the drawings. FIG. 1 is a partially broken perspective view showing one embodiment of a power transmission belt formed with an encoder on its surface according to the present invention. FIG. 2 is a similar drawing to FIG. 1 according to another embodiment. FIG. 3a to FIG. 3g are sectional views of respective modified embodiments of a power transmission belt formed with an encoder on its surface according to the present invention. FIG. 4 is a conceptual diagram when a power transmission belt formed with an encoder on its surface according to the present invention is applied to a belt of an auxiliary machine for engine and a rotation detection system of the belt is constituted. FIG. 5 is a time chart showing rotation detection pulse signals in the rotation detection system. FIG. 6 is a flow chart showing one embodiment of a production method of a power transmission belt formed with an encoder on its surface according to the present invention. FIG. 7 is a conceptual diagram showing one example of a fixing and forming procedure of a magnetic rubber layer according to the production method. FIG. 8 is a similar drawing showing another example of the procedure. FIG. 9 is a flow chart showing another embodiment of the production method of a power transmission belt formed with an encoder on its surface according to the present invention.

A power transmission belt formed with an encoder on its surface A shown in FIG. 1 is constituted such that a belt layer structure 1 of the belt for an endless power transmission belt comprises a rubber base layer 2 made of EPDM, a reinforcing layer 3 of filamentous body made of resin fiber embedded in the base layer 2 along the longitudinal direction, a surface layer 4 made of canvas of good quality, and a band-like magnetic rubber layer 5 integrally adhered and embedded in a groove part 1a which is formed by removing from the surface layer 4 to around the reinforcing layer 3 all around the circumference along the longitudinal direction. The lower face of the base layer 2 of the endless power transmission belt A is defined as the inner circumference, the surface layer 4 is defined as the outer circumference, and the lower face of the base layer 2 is designed to come into contact with a pulley when the belt is wound and wrapped through power transmission pulleys of a power transmission mechanism to be mentioned later. A plurality of rib parts 2a . . . are formed under the base layer 2 along the longitudinal direction.

The magnetic rubber layer 5 is adhered and integrated all around the belt layer structure 1 in the groove part 1a in such a manner that the surface of the magnetic rubber layer 5 is exposed onto the surface of the belt layer structure 1 at the side of the surface layer 4 and becomes identical to the surface of the surface layer 4. The magnetic rubber layer 5 is adhered and integrated in the groove part 1a by means of a rubber-based adhesive agent as mentioned above. The magnetic rubber layer 5 is formed like a band by mixing magnetic powder and a rubber material as mentioned above and the surface is formed as a multipolar magnetized surface 5a on which a plurality of N-poles 5aa . . . and S-poles 5ab . . . are alternately arranged at equal intervals along the longitudinal direction of the belt layer structure 1.

FIG. 2 shows another embodiment. The magnetic rubber layer 5 of a power transmission belt with an encoder on its surface B in the figure comprises a plurality of short band-like bodies. These plurality of short band-like magnetic rubber layers 5 . . . are adhered and integrated to the groove part 1a in embedded condition, the groove part 1a being formed by removing the belt layer structure 1 from the surface layer 4 to around the reinforcing layer 3 along the entire longitudinal direction at intervals, thereby constituting a discontinuous magnetic rubber layer 5. The surface of each short band-like magnetic rubber layer 5 is constituted as a multipolar magnetized surface 5a on which a plurality of N-poles 5aa . . . and S-poles 5ab . . . are alternately arranged at equal intervals along the longitudinal direction of the belt layer structure 1, as mentioned above. A plurality of rib parts 2b . . . are formed on the lower face of the base layer 2 along the width direction. The rib parts 2b similar to those in FIG. 2 may be used in the embodiment in FIG. 1 instead of the rib parts 2a along the longitudinal direction. Alternately, the rib parts 2a similar to those in FIG. 1 may be used in the embodiment in FIG. 2 instead of the rib parts 2b along the width direction. Other structures are same as those of the power transmission belt formed with an encoder A in FIG. 1.

FIG. 3a to FIG. 3g show modified examples of the power transmission belts having encoders on its surfaces A, B. In a power transmission belt formed with an encoder on its surface C in FIG. 3a, it is the same as the above-mentioned embodiments in that the magnetic rubber layer 5 is adhered and integrated to the groove part 1a in embedded condition and the surface 5a (multipolar magnetized surface) exposes onto the surface of the belt layer structure 1 at the surface layer 4 side, however, it is different from the above-mentioned embodiments in that the surface 5a of the magnetic rubber layer 5 does not become identical to the surface of the surface layer 4 and is dented in the width direction of the belt layer structure 1. A power transmission belt formed with an encoder on its surface D in FIG. 3b is different from the above-mentioned embodiments in that the magnetic rubber layer 5 is adhered and integrated in the groove part 1a in a half embedded condition, the surface 5a of the magnetic rubber layer 5 does not become identical to the surface of the surface layer 4 and projects out of the surface layer 4. Furthermore, a power transmission belt formed with an encoder on its surface E in FIG. 3c does not have such a groove part 1a as mentioned above and the magnetic rubber layer 5 is adhered and integrated to the surface of the surface layer 4 with an adhesive agent.

In a power transmission belt formed with an encoder on its surface F in FIG. 3d, the magnetic rubber layer 5 is adhered and integrated to the lower face of the base layer 2 with an adhesive agent. In a power transmission belt formed with an encoder on its surface G in FIG. 3e, the belt layer structure 1 has a plurality of penetrating parts 1b in a predetermined area along the longitudinal direction at equal intervals and the magnetic rubber layer 5 is inserted and integrated via an adhesive agent in the penetrating part 1b. The surface of the magnetic rubber layer 5 is exposed so as to become identical to the surface of the surface layer 4 and constitutes the multipolar magnetized surface 5a as mentioned above. The lower face of the magnetic rubber layer 5 is configured like the base layer 2 in such a manner that the lower face of the magnetic rubber layer 5 fits the lower surface of the base layer 2, however, the surface of the magnetic rubber layer 5 may be formed plane and constitute a multipolar magnetized surface. A power transmission belt formed with an encoder on its surface H in FIG. 3f is a combination of the power transmission belt D in FIG. 3b and the power transmission belt F in FIG. 3d, and is characterized in that a magnetic rubber layer 5 is provided on both faces of the belt layer structure 1. In a power transmission belt formed with an encoder on its surface I in FIG. 3g, the magnetic rubber layer 5 is adhered and integrated to the side face of the base layer 2 and the surface exposed onto the side face of the magnetic rubber layer 5 constitutes a multipolar magnetized surface 5a.

FIG. 4 shows an example in which the power transmission belt formed with an encoder as mentioned above is applied to a belt of an auxiliary machine for an automobile engine and a rotation (elongation) detection system of the belt is constituted. A crank shaft 7a is projected into the side part of an engine 6 and a crank pulley 7 is fixed to the crank shaft 7a. In addition, on the side face of the engine 6, a power transmission pulley for air conditioner 8, a power transmission pulley for water pump 9, a power transmission pulley for alternator 10, and a tension pulley 11, which correspond to each auxiliary machine to be transmitted with power, are supported in a rotatable manner around the axis. The power transmission belt formed with an encoder on its surface A is wound and wrapped through these pulleys 7, 8, 9, 10, 11 as shown in the figure. In this figure, the power transmission belt A is wound and wrapped such that, the inner side of the power transmission belt A, namely the lower face of the base layer 2 comes into contact with the power transmission pulleys 7, 8, 9, 10 and the outer side thereof, namely the surface of the surface layer 4, comes into contact with the tension pulley 11.

The power transmission belt formed with an encoder on its surface A in FIG. 4 is driven to be rotated at high speed while being wound and wrapped along many curves, so that a large bending stress is exerted. Therefore, such durability to withstand the severe conditions is required. Furthermore, in this example, the belt A is bent by the tension pulley 11 different from the direction bent by other power transmission pulleys 7, 8, 9, 10, so that a large extension stress difference is caused between the inside and the outside of the bent part. Therefore, the magnetic rubber layer 5 is required to have more than 10% degree of elongation according to such extension, thereby keeping required durability of such kind of power transmission belt.

A first magnetic sensor 12 is provided close to the outside of the power transmission belt formed with an encoder on its surface A between the pulley 7 and the pulley 8 and a second magnetic sensor 13 is provided at the pulley 8 close to the outside of the power transmission belt A, thereby constituting a rotation detection system of the power transmission belt A. The positions of the magnetic sensors 12, 13 are not limited to the positions in the figure and depend on the driven side (auxiliary machine) which is an object to detect rotation. To which surface of the power transmission belt formed with an encoder the magnetic sensor 12, 13 are closely provided is determined depending on the part formed with the multipolar magnetized surface 5a like the power transmission belts A to I.

Furthermore, the distance between the magnetic sensors 12, 13 is set in such a manner that the phase difference of output signals becomes zero or a predetermined value when no load is exerted to each auxiliary machine.

FIG. 5 is a time chart showing rotation detection pulse signals in the rotation detection system, S1 represents detection pulse signals by the magnetic sensor 12, and S2 represents detection pulse signals by the magnetic sensor 13. When the crank pulley 7 rotates in the direction of the arrow “a” in FIG. 4, the power transmission belt formed with an encoder on its surface A is driven to be rotated in the same direction, this rotation is followed by a regular and alternate magnetic change on the multipolar magnetized surface 5a by the N-poles 5aa and the S-poles 5ab, and the pulse signals S1, S2 without phase difference, as shown in the figure, are outputted till the time “t” when a clutch (not shown) of an air conditioner is turned on. Then, when the clutch of the air conditioner is turned on at the time “t” and load is applied to the power transmission pulley for air conditioner 8, the power transmission belt formed A produces elongation (strain) between the magnetic sensors 12, 13 and the pulse signals S2 cause phase difference of S1−(minus) S2 with respect to the pulse signals S1. Such phase difference is equal to the phase difference of the speed of the power transmission belt A in the position of the magnetic sensors 12, 13, thereby calculating the applied load by the air conditioner from the phase difference of the speed.

The applied load is calculated as mentioned above, the largest load for the belt is calculated and an optimum design for the width of the power transmission belt formed with an encoder on its surface A becomes possible. In addition, when the load for the power transmission belt A is monitored, optimization of the engine torque control can be executed such that the clutch for the air conditioner is turned off or the engine ignition timing is changed when load is applied, thereby increasing fuel economy.

The strain amount of the belt is recorded, and an alarm is raised when the recorded stain amount exceeds a threshold value, therefore a driver can be informed before the belt is broken, thereby improving safety.

In FIG. 4 and FIG. 5, when a clutch is provided for other auxiliary machines, the clutch (not shown) is turned off and the power transmission pulley for water pump 9 and the power transmission pulley for alternator 10 spin free. When the clutch of the auxiliary machine is turned on, the pulse signals S2 generated by applying load on the machines are outputted. The applied load as mentioned above can be calculated by comparing the rotation speed of the belt and the angular velocity of the crank.

FIG. 6 is a flow chart showing one embodiment of a production method of a power transmission belt formed with an encoder on its surface according to the present invention. The production method according to the present invention comprises following steps. A conventional power transmission belt is prepared (ST1), the surface is removed all along the longitudinal direction so as to form the groove part 1a as shown in FIG. 1 (ST2), and an unvulcanized rubber-based adhesive agent is applied in the groove part 1a (ST3). Meanwhile, a fixed amount of magnetic powder is mixed with the unvulcanized rubber material and a magnetic rubber material is prepared (ST4). Thus prepared magnetic rubber material is placed in the groove part 1a applied with an adhesive agent (ST5), heat and pressure are exerted by the method to be mentioned later, the rubber material is molded by a primary vulcanization, and the magnetic rubber material is fixed in the groove part 1a in such a manner that the surface of the magnetic rubber material becomes identical to the surface of the surface layer 4 of the belt layer structure 1 (ST6).

Next, thus formed structure is placed in an oven (not shown) and heated for a predetermined time, and the rubber of the magnetic rubber material is secondary vulcanized (ST7). In this heating and vulcanization, the rubber based adhesive agent is also cured and the magnetic rubber layer 5 is adhered and integrated in the groove part 1a. Finally, the surface of the magnetic rubber layer 5 is magnetized by a known magnetizing machine (not shown) (ST8), thereby obtaining the power transmission belt formed with an encoder on its surface A which has the multipolar magnetized surface 5a on which a plurality of N-poles 5aa and S-poles 5ab are alternately arranged at equal intervals (ST9). The secondary vulcanization in the step ST7 is not required depending on the behavior of the rubber material.

FIG. 7 and FIG. 8 diagrammatically show an example of systems for executing the above-mentioned steps ST3, ST5, ST6. In FIG. 7 the endless power transmission belt (belt layer structure) 1 on which the groove part 1a (show FIG. 1) is formed by removal in advance is wound and wrapped through the rollers 12, 13, 14 and the power transmission belt 1 is designed to run in the direction of an arrow “b” by rotating the rollers 12, 13, 14. A pair of heating and pressurizing rollers 15, 16 are provided between the rollers 12, 14 so as to sandwich the power transmission belt 1 from up and down. One of the heating and pressurizing rollers 15, 16 is designed to be a driving roller, the other is designed to be a driven roller, and the driving roller 15 rotates in the direction of an arrow “c”. An adhesive agent application device 17 is provided at the upstream side of the running direction “b” close to the heating and pressurizing rollers 15, 16.

In the system shown in FIG. 7, while rotation of the rollers 12, 13, 14 makes the power transmission belt 1 run in the direction of the arrow “b”, an adhesive agent is applied in the groove part 1a by means of the adhesive agent application device 17 and a magnetic rubber material 50 prepared in advance is continuously supplied between the pair of the heating and pressurizing rollers 15, 16. The supplied magnetic rubber material 50 is heated and pressurized by the heating and pressurizing rollers 15, 16 and is gradually fixed in the groove part 1a. When such fixing is executed all along the power transmission belt 1, the system is stopped and the power transmission belt 1 is removed and transferred to the next step. The rubber of the magnetic rubber material 50 is rendered to the primary vulcanization by such heating and pressurizing molding, and the magnetic rubber material 50 is continuously fixed in the groove part 1a in such a manner that its surface becomes identical to the surface of the surface layer 4 of the belt layer structure 1.

In the example of FIG. 8, heating and pressurizing boards 18, 19 are faced each other so as to hold the power transmission belt 1 from up and down, instead of providing a pair of heating and pressurizing rollers 15, 16. The rollers 12, 13, 14 are designed to intermittently rotate in the direction of an arrow “b”. Other structures are the same as those in FIG. 7.

In the system of FIG. 8, the rollers 12, 13, 14 are rotated while the heating and pressurizing boards 18, 19 are separated up and down, the power transmission belt 1 is designed to run the distance corresponding to the acting width of the heating and pressurizing boards 18, 19 in a direction of the arrow “b” and then to stop. During such running, an adhesive agent is applied in the groove part 1a by the adhesive agent application device 17 and in addition the magnetic rubber material 50 is formed like a band and is supplied in the groove part 1a. Next, the heating and pressurizing boards 18, 19 are moved close each other and the part where the magnetic rubber material 50 is supplied is held from up and down and heated. Accordingly, the supplied magnetic rubber material 50 is fixed in the groove part 1a. Thereafter, separation of the heating and pressurizing boards 18, 19 up and down, rotary driving of the rollers 12, 13, 14, application of an adhesive agent, and supply of the magnetic rubber material 50 are repeated; when the magnetic rubber material 50 is fixed all around the power transmission belt 1, the power transmission belt 1 is removed and transferred to the next step. The rubber of the magnetic rubber material 50 is primary vulcanized and the rubber material 50 is continuously fixed in the groove part 1a in such a manner that the surface becomes identical to the surface of the surface layer 4 of the belt layer structure 1.

The examples in FIG. 7 and FIG. 8 can be applied to the production method of the power transmission belt formed with an encoder on its surface B on which the magnetic rubber layer 5 is discontinuously formed as shown in FIG. 2 by appropriately setting how the groove part 1a is formed, how the adhesive agent is applied, how the magnetic rubber material 50 is supplied, and how the rollers 12, 13, 14 are driven to be rotated, in addition to the production method of the power transmission belt formed with an encoder on its surface A on which the magnetic rubber material 50 is continuously formed all around as shown in FIG. 1. Furthermore, the examples can be applied to the production method of the power transmission belts with encoders on its surface C to I which are modifications and shown in FIG. 3 by changing the above-mentioned settings.

FIG. 9 is a flow chart showing another embodiment of a production method of a power transmission belt formed with an encoder on its surface according to the present invention. This production method comprises the following steps. Preparing power transmission belt (ST10), forming the groove part 1a by removing the surface of the belt all along the longitudinal direction (ST20), and applying an unvulcanized rubber-based adhesive agent in the groove part 1a (ST30) are executed like the steps ST1 to ST3 as shown in FIG. 6. Meanwhile, a magnetic rubber material formed by mixing a fixed amount of magnetic powder in the unvulcanized rubber material is molded by vulcanization into a long band-like body and a band-like magnetic rubber sheet is prepared (ST40). Thus prepared band-like magnetic rubber is supplied to a known magnetizing apparatus (not shown), thereby forming a multipolar magnetized surface which is magnetized by alternately providing a plurality of N-poles and S-poles at equal intervals (ST50).

Next, the band-like magnetic rubber sheet on which the multipolar magnetized surface is formed is placed in the groove part 1a applied with an adhesive agent with the multipolar magnetizing surface facing up (ST60), and all the structure is heated and pressurized to cure the adhesive agent (ST70). Thus, the power transmission belt formed with an encoder on its surface A having the multipolar magnetized surface 5a on which a plurality of N-poles 5aa and S-poles 5ab are alternately provided at equal intervals is obtained (ST80).

The magnetizing step ST50 can be executed after the heating and pressurizing step ST70, and such modification can be done taking into consideration the production efficiency.

In the production methods shown in FIG. 6 and FIG. 9, a conventional power transmission belt is prepared by a simple manner, so that the power transmission belt formed with an encoder on its surface can be easily obtained. These methods produce the power transmission belt formed with an encoder on its surface A on which the magnetic rubber layer 5 is continuously formed all around the belt as shown in FIG. 1, however, they may produce the power transmission belt formed with an encoder on its surface B as shown in FIG. 2 on which the groove part 1a is discontinued, the magnetic rubber layer 5 is fixed in the discontinuous groove part 1a and the magnetic rubber layer 5 is discontinuously formed. In addition, these methods can produce the power transmission belts with encoders on its surface C to I like the modifications shown in FIG. 3 by changing the form (including existence) of the groove part 1a and other settings.

Furthermore, the production methods in FIG. 6 and FIG. 9 produce a power transmission belt formed with an encoder on its surface by processing a conventional power transmission belt, however, a magnetic rubber layer may be included in the belt layer structure when the power transmission belt itself is manufactured.

In the above-mentioned embodiments, the magnetic rubber layer 5 exposes onto the surface of the belt layer structure 1, however, it may be embedded in the thickness of the belt layer structure 1 as far as the magnetic power is detected. Also in the embodiments, the N-poles 5aa and the S-poles 5ab on the multipolar magnetized surface are arranged at equal intervals, however, they may not be arranged at equal intervals as far as the pulse width can be calculated. In this specification, the power transmission belt formed with an encoder according to the present invention is applied to the case wherein power is transmitted to an auxiliary machine of the automobile engine, however, it can be applied to a power transmission belt in the field of other industrial machines. The number of objects to be transmitted with power is not limited to the number in the embodiment in the figure, and it goes without saying that the number varies depending on the objects.

### REFERENCE SIGNS LIST

1 belt layer structure
5 magnetic rubber layer
5a multipolar magnetized surface
5aa N-pole
5ab S-pole
50 magnetic rubber material
A to I power transmission belt formed with an encoder on its surface

1-13. (canceled)

14. A power transmission belt formed with an encoder on its surface, comprising a band-like magnetic rubber layer provided in a part of a belt layer structure of the power transmission belt which transmits power to an auxiliary machine of an automobile engine along the longitudinal direction of said belt layer structure, a surface of said magnetic rubber layer constituting a multipolar magnetized surface alternately provided with N-poles and S-poles along the longitudinal direction of said belt layer structure, said surface of said magnetic rubber layer being capable of outputting signals for calculating load applied to said belt layer structure by said auxiliary machine to a plurality of magnetic sensors provided along the longitudinal direction of said belt layer structure, and one of said sensors being provided at a position where said auxiliary machine is provided.

15. The power transmission belt formed with an encoder as set forth in claim 14, wherein said surface of said magnetic rubber layer exposes onto a surface of said belt layer structure.

16. The power transmission belt formed with an encoder as set forth in claim 15, wherein said magnetic rubber layer is designed in such a manner that said surface of said magnetic rubber layer becomes identical to a surface of said belt layer structure.

17. The power transmission belt formed with an encoder as set forth in claim 14, wherein said magnetic rubber layer is continuously formed all around the circumference of said belt layer structure.

18. The power transmission belt formed with an encoder as set forth in claim 14, wherein a plurality of said magnetic rubber layers are formed at intervals all around the circumference of said belt layer structure.

19. The power transmission belt formed with an encoder as set forth in claim 14, wherein said N-poles and said S-poles are provided at equal intervals.

20. The power transmission belt formed with an encoder as set forth in claim 14, wherein said magnetic rubber layer is integrally adhered to said belt layer structure with a rubber-based adhesive agent.

21. A production method of the power transmission belt formed with an encoder on its surface of claim 14, comprising the steps of:
applying an uncured rubber-based adhesive agent onto said belt layer structure of said power transmission belt along its longitudinal direction;
placing on a part applied with the adhesive agent a magnetic rubber material prepared in advance by mixing magnetic powder with an unvulcanized rubber material;
heating all the structures at a vulcanization temperature of said unvulcanized rubber material to fixedly form said magnetic rubber layer of which said surface exposes onto a surface of said belt layer structure; and thereafter
forming said multipolar magnetized surface by alternately providing N-poles and S-poles at equal intervals along the longitudinal direction of said belt layer structure.

22. A production method of the power transmission belt formed with an encoder on its surface of claim 14, comprising the steps of:
applying a rubber-based adhesive agent onto said belt layer structure of said power transmission belt along its longitudinal direction;
placing a band-like magnetic rubber sheet on a part applied with said rubber-based adhesive agent to be integrally adhered, a surface of said band-like magnetic rubber sheet constituting said multipolar magnetized surface by alternately providing N-poles and S-poles at equal intervals along its longitudinal direction.

23. The production method of the power transmission belt formed with an encoder as set forth in claim 21, wherein said adhesive agent is applied onto a removed part of said belt layer structure and said removed part and said magnetic rubber layer are integrally formed with an adhesive agent.

24. The production method of the power transmission belt formed with an encoder as set forth in claim 23, wherein said magnetic rubber layer is designed in such a manner that said surface of said magnetic rubber layer becomes identical to a surface of said belt layer structure.

25. The production method of the power transmission belt formed with an encoder as set forth in claim 21, wherein said magnetic rubber layer is continuously formed all around the circumference of said belt layer structure.

26. The production method of the power transmission belt formed with an encoder as set forth in claim 21, wherein a plurality of said magnetic rubber layers are formed at intervals around the circumference of said belt layer structure.

27. A load detection system using a power transmission belt formed with an encoder on its surface, comprising:
said power transmission belt formed with an encoder on its surface as set forth in claim 14 which is wound and wrapped to a belting structure of an auxiliary machine of an automobile engine;
a plurality of magnetic sensors provided along the longitudinal direction of a belt layer structure of said power transmission belt formed with an encoder on its surface to detect signals generated from said magnetic rubber layer, one of said sensors being provided at a position where an auxiliary machine is provided; and
an operation means for calculating load applied to said belt layer structure by said auxiliary machine based on signals detected by said magnetic sensor.

28. The power transmission belt formed with an encoder as set forth in claim 14, wherein distance between said magnetic sensors is set in such a manner that phase difference of output signals without applying load to said auxiliary machine is set to be zero or to be a fixed difference, applied load to said auxiliary machine is calculated by said phase difference, and engine torque control is capable of being optimized when the load is applied.

29. The production method of the power transmission belt formed with an encoder as set forth in claim 21, wherein distance between said magnetic sensors is set in such a manner that phase difference of output signals without applying load to said auxiliary machine is set to be zero or to be a fixed difference, applied load to said auxiliary machine is calculated by said phase difference, and engine torque control is capable of being optimized when the load is applied.

30. The load detection system using a power transmission belt formed with an encoder as set forth in claim 27, wherein distance between said magnetic sensors is set in such a manner that phase difference of output signals without applying load to said auxiliary machine is set to be zero or to be a fixed difference, applied load to said auxiliary machine is calculated by said phase difference, and engine torque control is capable of being optimized when the load is applied.

31. The power transmission belt formed with an encoder as set forth in claim 14, wherein said auxiliary machine is at least one of machines of an automobile engine selected from an air conditioner, a water pump, and an alternator.

32. The production method of the power transmission belt formed with an encoder as set forth in claim 21, wherein said auxiliary machine is at least one of machines of an automobile engine selected from an air conditioner, a water pump, and an alternator.

33. The load detection system using the power transmission belt formed with an encoder as set forth in claim 27, wherein said auxiliary machine is at least one of machines of an automobile engine selected from an air conditioner, a water pump, and an alternator.
